(19) United States
(12) Patent Application Publication
(10) Pub. No.: US 2007/0126918 A1
(43) Pub. Date: Jun. 7, 2007

(54) Cameras with multiple sensors

(76) Inventor: Chulhee Lee, Goyang-City (KR)

Correspondence Address: Chulhee Lee;Dept. Electrical and Electronic Eng., Yonsei University, 134 Shinchon-Dong, Seodaemoon-Gu, Seoul, 120-749, KR

(21) Appl. No.: 11/699,038

(22) Filed: Jan. 29, 2007

Related U.S. Application Data
(62) Division of application No. 10/335,848, filed on Jan. 3, 2003, now abandoned.

(51) Int. Cl. G03B 13/00

(52) U.S. Cl. 348/345

(57) ABSTRACT

Cameras that can provide improved images by combining several shots of a scene taken with different exposure and focus levels is provided. In addition, cameras are provided, which have pixel-wise exposure control means so that high quality images are obtained for a scene with a high level of contrast. Furthermore, cameras are also provided, which have a number of imaging sensing means that can operator at different focus and exposure levels. Cameras that can take several images or videos of a scene with different exposure and focus levels and save all the images or videos for future processing are also provided.

### BACKGROUND OF THE INVENTION

1. Field of the Invention

This application is a divisional of application Ser. No. 10/335,848 filed Jan. 3, 2003 entitled “Cameras”, status pending, which is herein incorporated by reference.

This invention relates to cameras that provide improved images by combining several shots of a scene taken with different exposure and focus levels. It also relates to cameras that have pixel-wise exposure control means so that high quality images are obtained for a high-contrast scene. This invention further relates to cameras that have a number of imaging sensing means that can operator at different focus and exposure levels.

2. Description of the Related Art

In order to take high quality images or videos with a camera, the exposure and focus levels need to be well adjusted. However, in many circumstances, it is very difficult to obtain the optimal exposure and focus levels for all objects. For instance, it is difficult to maintain objects in focus, which are widely scattered along the z-axis. It is also difficult to find an optimal exposure level for objects in a scene with a high level of contrast.

The z-axis is the screen depth that extends from the camera lens to infinity. The depth of field is the area of the z-axis in which objects are in focus. Typically, when zoomed in, the depth of field is more shallow than when zoomed out. Furthermore, a large aperture leads to a shallow depth of field. Thus, when objects are widely scattered along the z-axis, it is difficult to maintain focus among all of the objects. The present invention solves this problem by taking several images of the objects with different focus levels. Then, the camera produces a new sharper image by combining these several images.

When the contrast is too high, it is difficult to find an optimal exposure level for all objects. In a high-contrast scene, either the bright areas look overexposed or small differences in the dark regions appear uniformly black. The present invention also solves this problem by taking several shots of the objects with different exposure levels. Then, the camera produces a new detailed image by combining these several images.

When one tries to combine several images that are taken with different focus or exposure levels over a period of time, the images first need to be registered since the images may be slightly shifted against each other due to shaking of the camera or the movement of objects. Although most of these kinds of unintended shifting can be corrected through a registration operation that includes shift and rotation, some kind of distortion may be inevitably introduced. In order to solve this problem, the present invention provides a camera that has several image sensors that can operator at different focus or exposure levels. Such a camera can take several shots of a scene with different focus and exposure levels simultaneously so that it can avoid the distortion caused by an imperfect registration.

On the other hand, when taking motion pictures of objects that are widely scattered along the z-axis, the camera operator should choose an object that needs to be in focus. In general, if the objects are widely scattered along the z-axis, it is extremely difficult to keep all the objects in focus with a video camera. The present invention also solves this problem by recording the objects with different focus levels simultaneously using several image sensors that can operator at different focus levels and then combines the videos to produce a sharper video.

When the contrast is too high, it is difficult to find an optimal exposure level for all objects with a video camera. The present invention solves this problem by simultaneously taking several videos of the objects using several image sensors that have different exposure levels and then combines the videos to produce a detailed video. However, if there are several sensors, the camera becomes large and expensive. As an alternative solution for the high-contrast problem, the present invention provides pixel-wise exposure control means. Consequently, it is possible to obtain good images in a scene with a high level of contrast.

### SUMMARY OF THE INVENTION

Thus, it is an object of the present invention to provide cameras that are capable of taking several images of objects with different focus levels and produce a new sharper image by combining these several images.

It is another object of the present invention to provide cameras that take several shots of objects with different exposure levels and produce a new detailed image by combining these several images.

It is a further object of the present invention to provide a camera that has several image sensors, which can operator at different focus and exposure levels, so that it can take simultaneously several images of a scene with different focus and exposure levels.

It is still another object of the present invention to provide cameras that have pixel-wise exposure control means.

The other objects, features and advantages of the present invention will be apparent from the following detailed description.

### BRIEF DESCRIPTION OF THE DRAWINGS

FIG. 1 shows a front view of a camera.

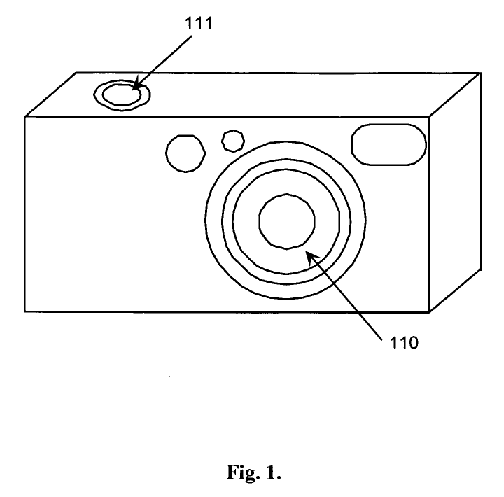

FIG. 2 shows a rear view of a camera that has a touch-pad as selecting means.

FIG. 3 shows a rear view of a camera that has a joystick as selecting means.

FIG. 4 shows an example of a scene where objects are widely scattered along the z-axis.

FIG. 5 shows an example of pointing means and illustrates how it can be used to select an object of interest.

FIG. 6 shows how a window frame can be used to select an object of interest.

FIG. 7 shows how a window frame can be used to select a number of objects of interest.

FIG. 8 shows how an object of interest is locked when the shutter button is slightly pressed, even though the window frame is moved.

FIG. 9 shows an example of a camera that has multiple sensors that can operator at different focus levels.

FIG. 10 shows an example of a camera that has multiple sensors that can operator at different focus levels. The incoming light is focused on the nearest object.

FIG. 11 shows an example of a camera that has multiple sensors that can operator at different focus levels. The incoming light is focused on the furthermost object.

FIG. 12 shows an example of a CCD (charge-coupled device).

FIG. 13 shows an example of the color filter array CCD (Bayer).

FIG. 14 shows an example of pixel-wise exposure control means utilizing an LCD (liquid crystal display).

FIG. 15 shows another example of pixel-wise exposure control means utilizing an LCD. The resolution of the LCD is lower than that of the CCD.

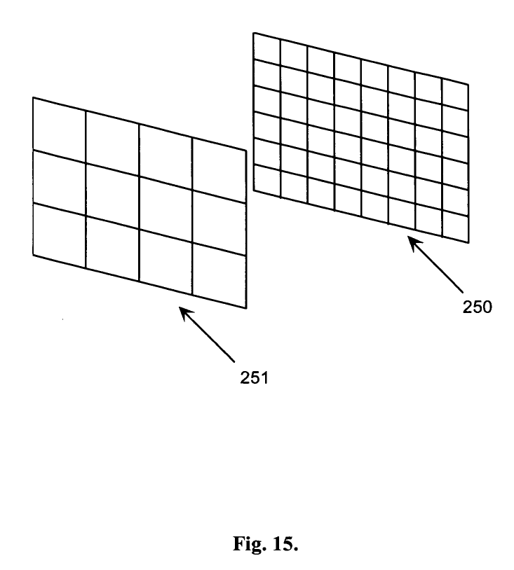

FIG. 16 shows an example of pixel-wise exposure control means utilizing an LCD for analog film.

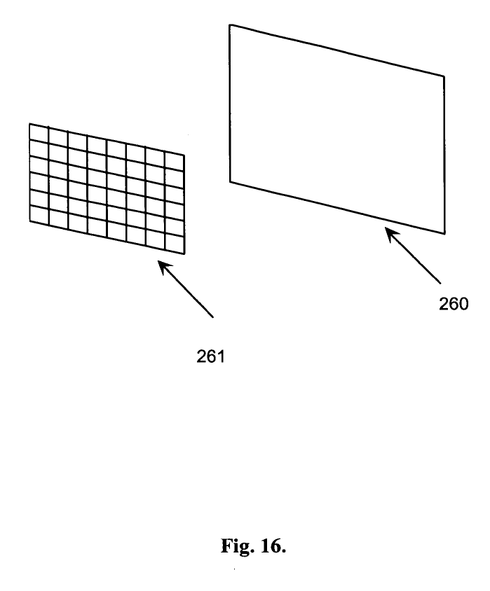

FIG. 17 shows an example of a DMD (digital micromirror device).

FIG. 18 shows an example of pixel-wise exposure control means utilizing a DMD (digital micromirror device).

FIG. 19 shows an example of a camera that has multiple sensors which can operator at different focus levels with pixel-wise exposure control means utilizing a DMD (digital micromirror device).

FIG. 20 illustrates how the DMD works.

FIG. 21 shows an example of a camera that has multiple sensors that can operator at different exposure levels.

FIG. 22 shows an example of a camera that has multiple sensors that can operator at different focus and exposure levels.

### DESCRIPTION OF THE ILLUSTRATED EMBODIMENTS

Since videos can be understood as a sequence of images (frames or fields), the idea and teaching of the present invention can be applied to both still image cameras and videos cameras. Furthermore, the distinction between still image cameras and video cameras is becoming blurred. When there are some differences, they will be explained.

### Embodiment 1

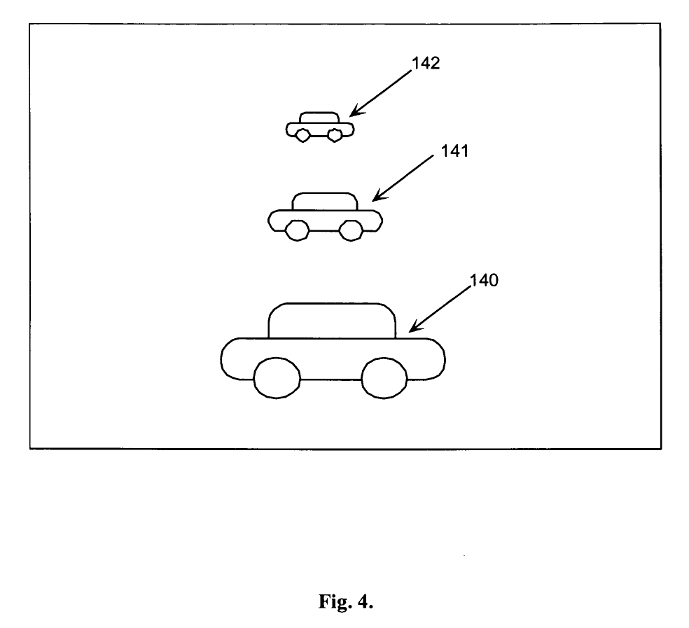

The z-axis is the screen depth that extends from the camera lens 110 to infinity. The depth of field is the area of the z-axis in which objects are in focus. Typically, when zoomed in, the depth of field is more shallow than when zoomed out. Furthermore, a large aperture leads to a shallow depth of field. Thus, when objects 140, 141, 142 are widely scattered along the z-axis as shown in FIG. 4, it is difficult to maintain all the objects in focus. The present invention solves this problem by taking several images of the objects with different focus levels. Then, the camera produces a new sharper image by combining these several images. It is noted that the images should be stored in a digital format. For instance, possible image storing means include a nonvolatile memory, hard drive, and a magnetic tape that can record digital data.

It is noted that the camera takes several images of the objects with different focus levels, even though the user presses the shutter button 111 only once, and produces a sharper image by combining the several images. For instance, the first shot is focused on the nearest object 140 and the second shot is focused on the next nearest object 141. Finally, the third shot is focused on the furthermost object 142. Then, the camera registers these three images using a registration operation and combines them to produce a sharper image where all of the objects are in focus. The registration operation is required since the images, which are taken over a period of time, may be shifted against each other. It is noted that these three shots are taken even though the user presses the shutter button 111 only once.

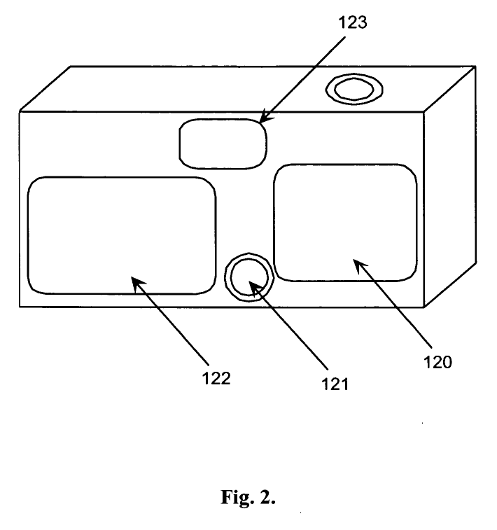

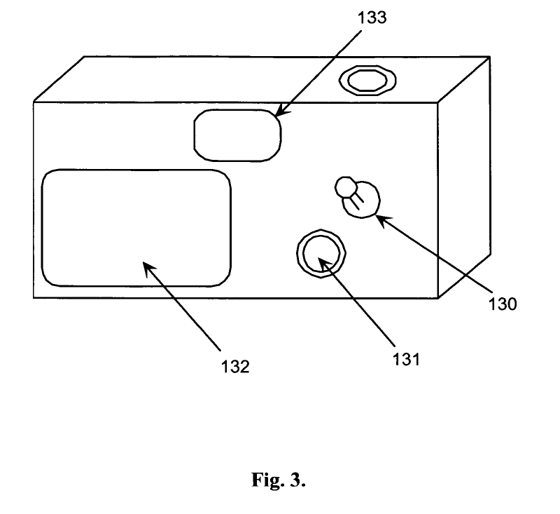

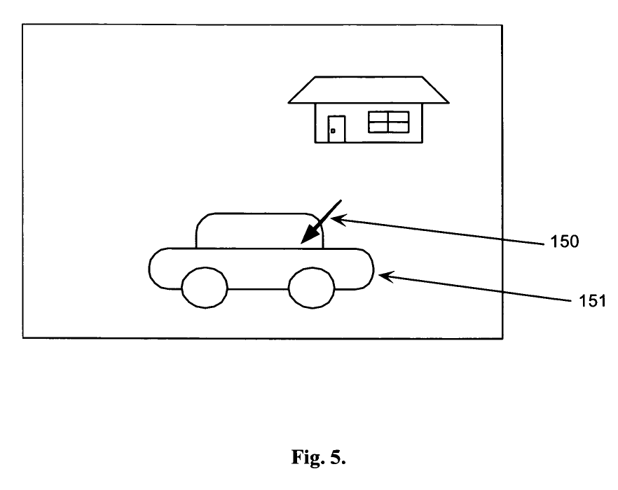

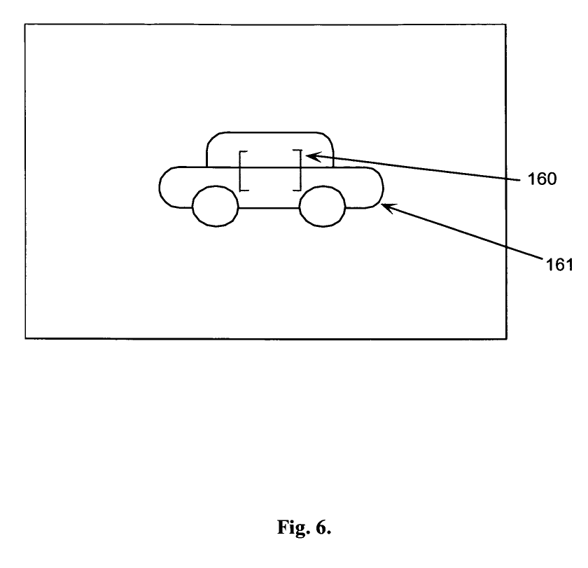

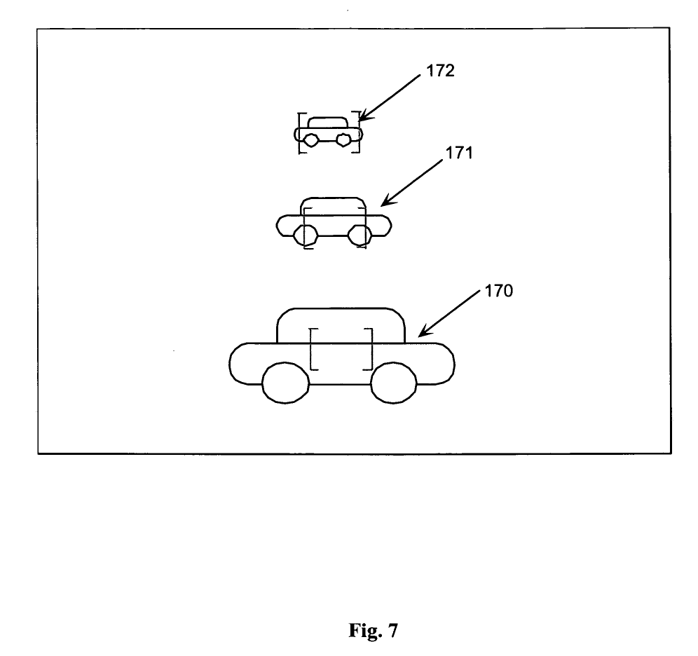

Furthermore, the present invention provides a camera shot-number choosing means so that a user can choose how many shots are needed to be taken. In other words, the user can choose the number of objects that need to be in focus. If the number of images is one, it will be equivalent to a conventional camera that takes a shot at each time the shutter button is pressed. FIG. 2 shows the rear view of a camera which has a viewfinder 123, an LCD 122, a touch-pad 120 and an object-selecting button 121. FIG. 3 shows the rear view of a camera that has a view finder 133, an LCD 132, a joystick 130 and an object-selecting button 131. The user can select objects that need to be in focus using pointing means 150 as illustrated in FIG. 5. The pointing means 150 can be moved by a joystick 130 or a touch-pad 120. When the pointing means 150 points an object 151 that needs to be in focus, the user presses the object-selecting button 121, 131 to choose the object. Alternatively, a user places an object 161 inside a window frame 160 and slightly presses the shutter button as illustrated in FIG. 6. Then, the camera assumes that the object 161 inside the window frame 160 is the object of interest that needs to be in focus. In either way, the camera can determine how many shots should be taken. FIG. 7 illustrates how three objects 170, 171, 172 that are scattered along the z-axis can be selected using the window frame. For instance, the user places the nearest object 170 inside the window frame and slightly presses the shutter button. Then, the user places the second nearest object 171 inside the window frame and slightly presses the shutter button. Finally, the user places the furthermost object 172 inside the window frame and slightly presses the shutter button. In order to provide a review of the selected objects, the camera can display the selected objects in highlights, in different colors, or by using contours. Although this idea and teaching can be applied to video cameras, there would be some technical difficulty since a fast focus mechanism is required in video cameras.

### Embodiment 2

When one tries to combine several images that are taken with different focus levels over a period of time, the images first need to be registered. Due to the shaking of the camera and the movements of objects, the images may be slightly shifted against each other. Although most of this kind of shift can be corrected through use of the registration operation which includes shift and rotation, some kind of distortion may be inevitably introduced. In order to solve this problem, the present invention provides a camera that has several sensors that can operator at different focus levels.

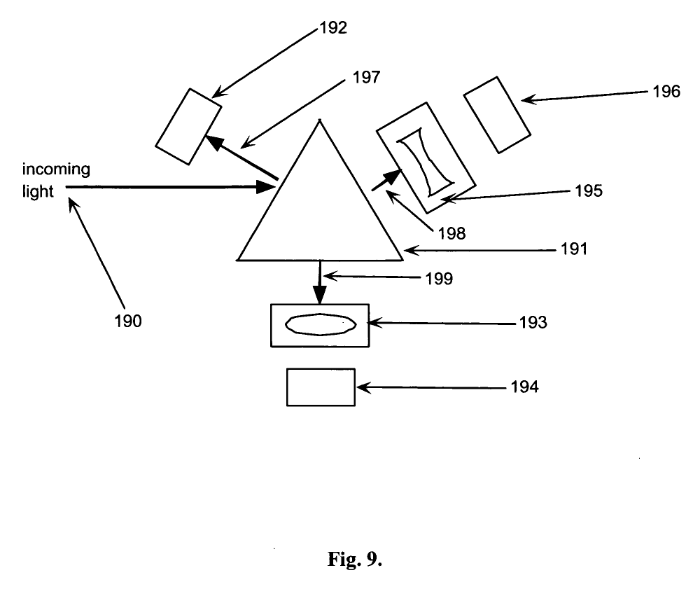

For instance, FIG. 9 shows an example of a camera that has several sensors. First, the incoming light 190 is split into three beams by a prism 191. It is assumed that the incoming light 190, which is coming through the main lens barrel, is focused on an object in the middle. The camera has two focus-adjusting means. The long-distance focus-adjusting means 195 corrects blurred images of the objects that are out of focus due to long distance. The short-distance focus-adjusting means 193 corrects blurred images of the objects that are out of focus due to short distance. In other words, the first split light 197 is sensed by the first sensor 192. The second split light 198 goes through the long-distance focus-adjusting means 195 and is sensed by the second sensor 196. Finally, the third split light 199 goes through the short-distance focus-adjusting means 193 and is sensed by the third sensor 194. Finally, the three sensors convert the light into electrical signals and these three signals are combined to produce a sharper image or video.

Thus, this camera can take several shots of a scene with different focus levels simultaneously and there won't be distortion due to the shaking of the camera or movements of the objects over a period of time. After several images are taken simultaneously, those images are combined to produce a sharper image. It is noted that this idea of the present invention can be applied to both still image cameras and video cameras.

It is noted that the image sensing means (192, 194, 196) can be a CFA CCD or three color CCD or any other sensor. It is also noted that the focus-adjusting means can be a zoom-lens type. Such focus-adjusting means can handle blurred imaged due to both long distance and short distance.

### Embodiment 3

Sometimes, a camera operator intentionally wants to have a shallow depth of field. With a shallow depth of field, one can emphasize an object of interest. In order to obtain this kind of effect, a high power zoom lens or telephoto lens is typically required. However, the idea and teaching of the present invention can be used to obtain this kind of effect without such expensive lens. First, the user selects an object of interest 151 using pointing means 150. The pointing means can be moved within the viewfinder using a joystick 130 or a mouth-pad 120 or the kind, as described previously. Then the camera applies a segmentation method to extract the area of the object of interest 151. Then, the camera takes several shots with different focus levels and determines which shot provides the sharpest image for the object of interest. It also determines which shots provide blurred images for the background. Finally, the camera produces a new image where only the object of interest is in focus and the background objects are out of focus. It is noted that the camera takes several images of the objects with different focus levels even though the user presses the shutter button only once, as previously explained. Furthermore, it is possible for the user to select more than one object, which needs to be in focus.

It might be helpful for a camera operator if the camera displays objects along the z-axis in such a way that the camera operator can distinguish the objects according to the distance from the camera. This can be done using highlights, by using different colors or using contours. For instance, the objects of interest can be highlighted with the background darkened.

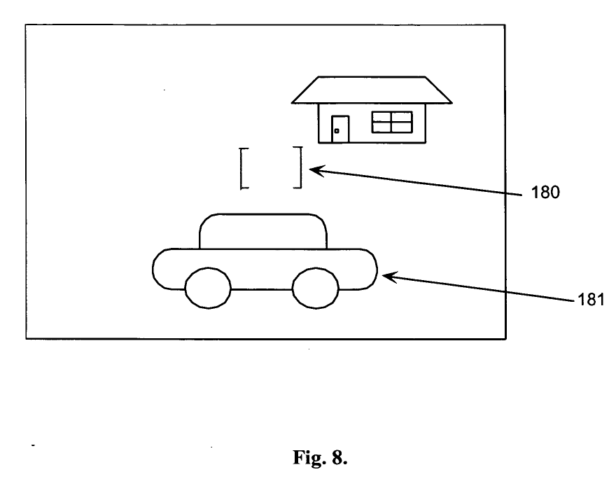

As another way to implement this kind of camera, a user places the object of interest 161 inside a window frame 160 and slightly presses the shutter button 111. Then, the camera assumes that the object 161 inside the window frame 160 is the object of interest and finds the optimal focus level for the object of interest. Then, the camera takes several shots with different focus levels when the user presses the shutter button 111 fully and determines the area of the object of interest. Finally, the camera produces a new image where only the object of interest is in focus and the background objects are out of focus by combining these several images. It is noted that the camera remembers the location of the object of interest 181 even though the window frame 180 is moved as illustrated in FIG. 8.

### Embodiment 4

When the contrast is too high, it is difficult to find an optimal exposure level for all objects. In a high-contrast scene, either the bright areas look overexposed or small differences in the dark areas appear uniformly black. The present invention also solves this problem by taking several shots of the objects with different exposure levels. For instance, if three shots are to be taken, the first image is taken with an optimal exposure level for the brightest object. A second shot is taken with an optimal exposure for medium-bright objects. Finally, a third shot is taken with an optimal exposure level for dark objects. Then, the camera produces a new detailed image by combining these several images. It is noted that the camera takes several images of the objects with different exposure levels even though the user presses the shutter button only once.

By combining multiple shots taken with different focus and exposure levels, one can obtain various special effects. For instance, the exposure and focus levels are optimized for an object of interest while the background is completely white or dark. According to the teaching of the present invention, these kinds of special effects can be incorporated in a camera.

### Embodiment 5

When one tries to combine several images that are taken with different exposure levels over a period of time, the images need to be registered. Due to the shaking of the camera and movements of objects, the images may be slightly shifted against each other. Although most of this kind of shift can be corrected through the registration operation which includes shift and rotation, some kind of distortion may be inevitably introduced. In order to solve these problems, the present invention provides a camera that have several sensors that can operator at different exposure levels. Thus, this camera can take several shots of a scene with different exposure levels simultaneously and there won't be any distortion due to the shaking of the camera or the movement of the objects over a period of time. After several images are taken with different exposure levels simultaneously, those images are combined to produce an image where the exposure level is optimal for all objects. It is noted that this embodiment can be used for both video and still cameras.

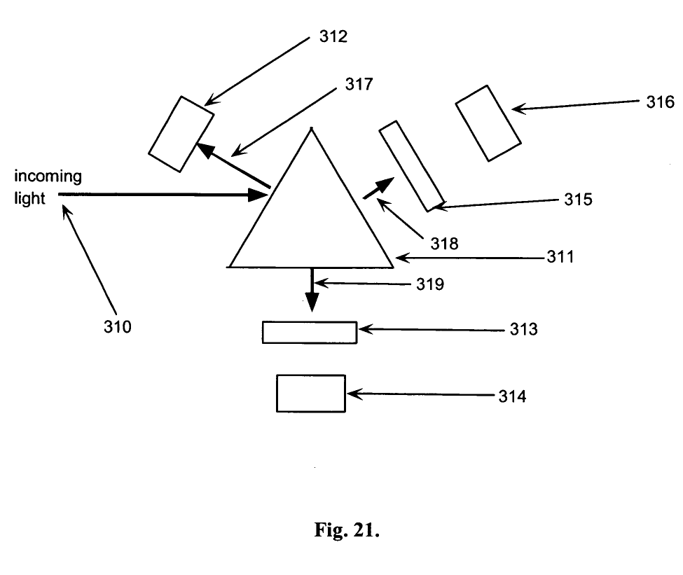

FIG. 21 shows an example of the camera that has several sensors, which can operator at different exposure levels. First, the incoming light 310 is split into three beams by a prism 311. It is assumed that the incoming light 310, which is coming through the main lens barrel, is optimized for the darkest object. The camera has two exposure-adjusting means. The first exposure-adjusting means 315 slightly reduces the amount of light that reaches a second sensor 316 for medium-bright objects. The second exposure-adjusting means 313 significantly reduces the amount of light that reaches a third sensor 314 for bright objects. Finally, the three sensors convert the light into electrical signals and these three signals are combined to produce an image or video with optimal exposure levels for all objects.

In other words, the first split light 317 is sensed by the first sensor 312. The second split light 318 goes through the first exposure-adjusting means 315 and is sensed by a second sensor 316. Finally, the third split light 319 goes through the second exposure-adjusting means 313, and is sensed by a third sensor 314. Finally, the three sensors convert the light into electrical signals and these three signals are combined to produce a sharper image or video with optimal exposure levels for all objects.

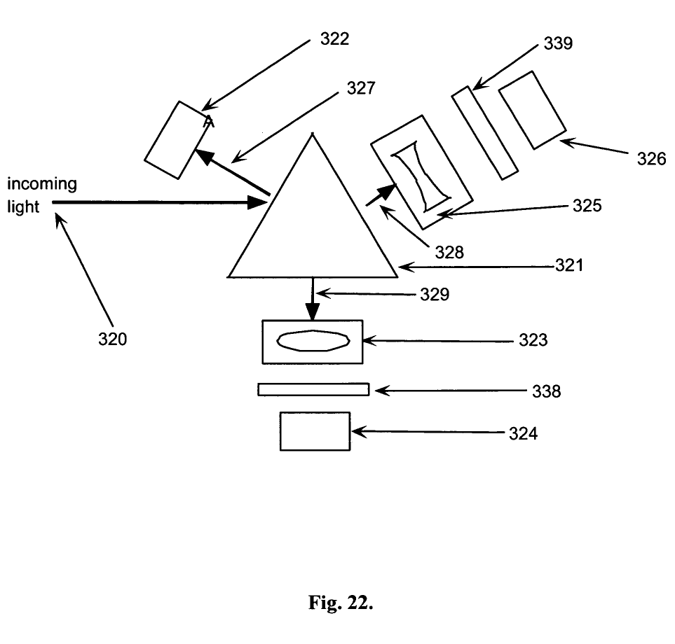

FIG. 22 shows an example of the camera that has several sensors, which can operator at different focus and exposure levels. First, the incoming light 320 is split into three beams by a prism 321. It is assumed that the incoming light 320, which is coming through the main lens barrel, is focused on an object in the middle and is optimized for the darkest object. The camera has two focus-adjusting means. The long-distance focus-adjusting means 325 corrects blurred images of the objects that are out of focus due to long distance. The short-distance focus-adjusting means 323 corrects blurred images of the objects that are out of focus due to short distance. In addition, the camera has two exposure-adjusting means. The first exposure-adjusting means 339 slightly reduces the amount of light that reaches a second sensor 326 for medium-bright objects. The second exposure-adjusting means 338 significantly reduces the amount of light that reaches a third sensor 324 for bright objects.

In other words, the first split light 327 is sensed by the first sensor 322. The second split light 328 goes through the long-distance focus-adjusting means 325 and the first exposure-adjusting means 339, and is sensed by a second sensor 326. Finally, the third split light 329 goes through the short-distance focus-adjusting means 323 and the second exposure-adjusting means 338, and is sensed by a third sensor 324. Finally, the three sensors convert the light into electrical signals and these three signals are combined to produce a sharper image or video with optimal focus and exposure levels for all objects.

### Embodiment 6

On the other hand, when a camera operator is taking motion pictures of objects that are widely scattered along the z-axis, the camera operator should choose an object that needs to be in focus. In general, if the objects are widely scattered along the z-axis, it is extremely difficult to keep all the objects in focus with a video camera. The present invention also solves this problem by recording the objects with different focus levels simultaneously using several sensors and then combines the video signals from the sensors to produce a sharper video. For instance, Embodimemt 2 can be also used for video cameras (FIG. 9).

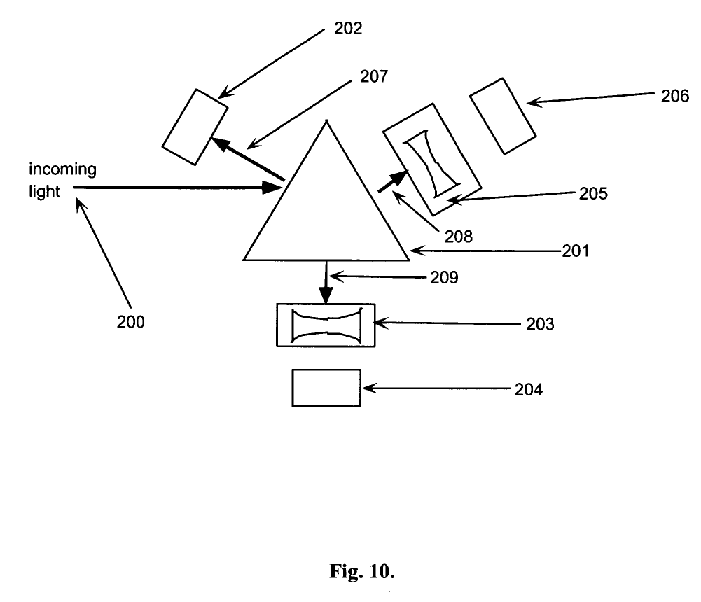

FIG. 10 shows another example of such embodiments. The incoming light 200, which is coming through the main lens barrel, is focused on the nearest object. First, the incoming light is split by a prism 201 into three beams 207, 208, 209. The camera has two focus-adjusting means. The medium-distance focus-adjusting means 205 corrects blurred images of the objects that are out of focus due to medium distance. The long-distance focus-adjusting means 203 corrects blurred images of the objects that are out of focus due to long distance. It is noted that the image sensing means (202, 204, 206) can be a CFA CCD or three color CCD or any other sensor.

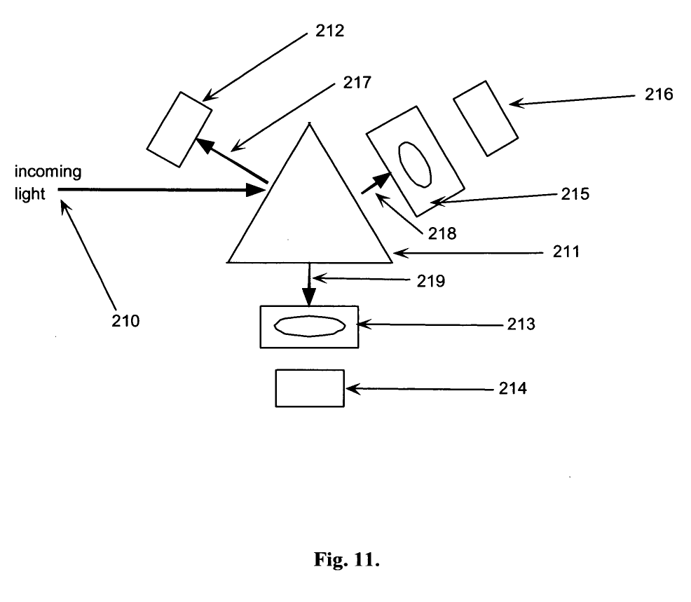

FIG. 11 still shows another example of such embodiments. The incoming light 210, which is coming through the main lens barrel, is focused on the furthermost object. First, the incoming light is split by a prism 211 into three beams 217, 218, 219. The camera has two focus-adjusting means. The medium-distance focus-adjusting means 213 corrects blurred images of the objects that are out of focus due to medium distance. The short-distance focus-adjusting means 215 corrects blurred images of the objects that are out of focus due to short distance. It is noted that the image sensing means (212, 214, 216) can be a CFA CCD or three color CCD.

It is noted that the number of focus-adjusting means can vary depending on the application.

### Embodiment 7

The current technology can produce a sensor or film that has a certain dynamic range. A major problem with this kind of sensor or analog film is that their dynamic ranges are rather limited compared to the dynamic range of the natural lighting condition. In order to handle this problem, the camera is usually equipped with means to control the size of the iris and exposure time. By varying the size of the iris and the exposure time, the camera can handle a wide range of light conditions, though the actual dynamic range is limited for the fixed iris and the exposure time. In case of video cameras, the exposure time is typically fixed and exposure level is adjusted by changing the size of the iris. In other words, by adjusting the size of the iris, the camera operator chooses an adequate exposure level for an object of interest.

However, when the level of contrast is too high, it is difficult to find an optimal exposure level for all objects with a video camera. The idea and teaching of the present invention can be used to solve this problem by taking several shots of the objects with different exposure levels using several sensors and then combining the videos to produce a more detailed video. However, if there are several sensors, the camera becomes large and expensive. As an alternative solution for the high-contrast problem, the present invention provides pixel-wise exposure control means.

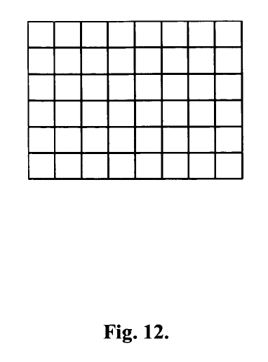

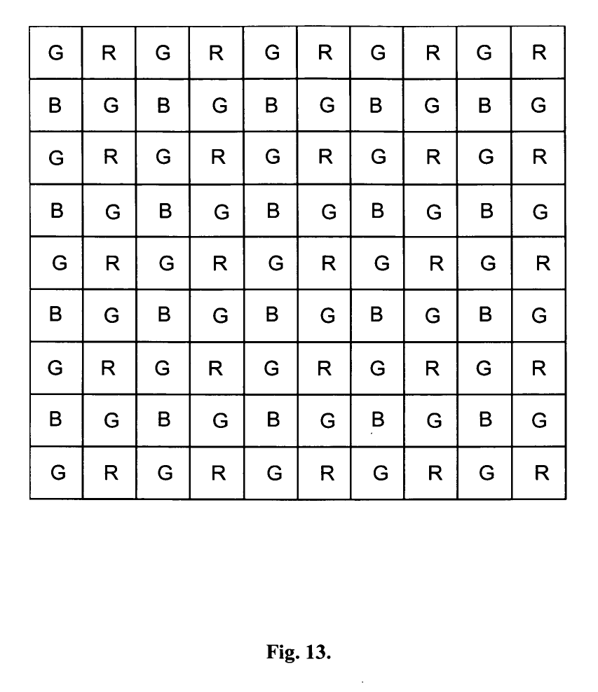

In many cameras, a CCD (charge-coupled device) is widely used as an image sensor. FIG. 12 shows an example of the CCD. In order to record color images, three color CCDs or color filter array (CFA) CCDs are used. FIG. 13 shows an example of the color filter array CCD (Bayer). It is noted that the idea and teaching of the present invention can be applied to any type of CCD.

According to the idea and teaching of the present invention, in front of a CCD or any other image sensing means, the camera has pixel-wise exposure control means. The pixel-wise exposure control means can be implemented using an LCD (liquid crystal display). By controlling applied voltage, the LCD can be made either transparent, partially transparent or nearly opaque. In other words, the LCD can be used to control the amount of light that reaches the CCD sensor or film or any other light sensing means. There are two possible ways to control the amount of light that reaches the sensor by using the LCD. In order to take a shot of scene with a high level of contrast, the LCD can be made partially transparent for a bright area. The opaqueness of the LCD is made in proportion to the brightness of the area. The second possibility is to change the exposure time by adjusting the LCD. In other words, for a bright area, the LCD is made opaque after the short exposure time and for a dark area the LCD remains transparent for a longer time. However, due to the rather slow response time of the LCD, the applicability is limited.

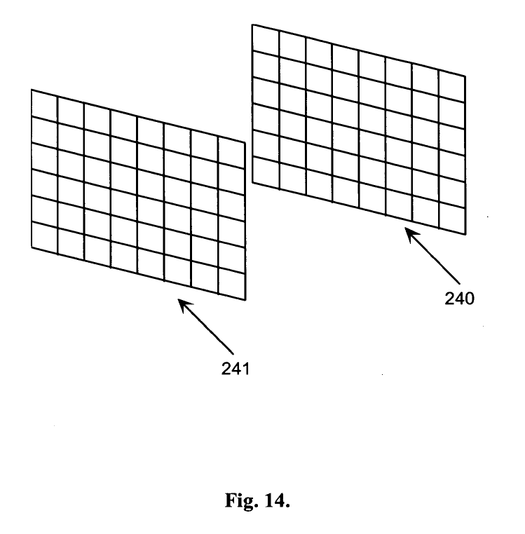

FIG. 14 illustrates a camera that has pixel-wise exposure control means 241. The pixel-wise exposure control means 241 is implemented using an LCD. For a bright area, the corresponding pixels of the LCD are made opaque, thus limiting the amount of light that reaches the sensing means 240. For a dark area, the corresponding pixels of the LCD are made transparent, thus allowing all of the available light to reach the sensing means 240. It is noted that the resolution of the LCD 251 as exposure control means does not need to be the same as that of the CCD sensor 250. For instance, if the CCD sensor has a 4 mega-pixel resolution, the LCD for exposure control may have a 1-mega-pixel resolution. It is also noted that the sensing means can be any light sensing means, including films and a CCD. For instance, the pixel-wise exposure control means 261 can be placed in front of analog film 260

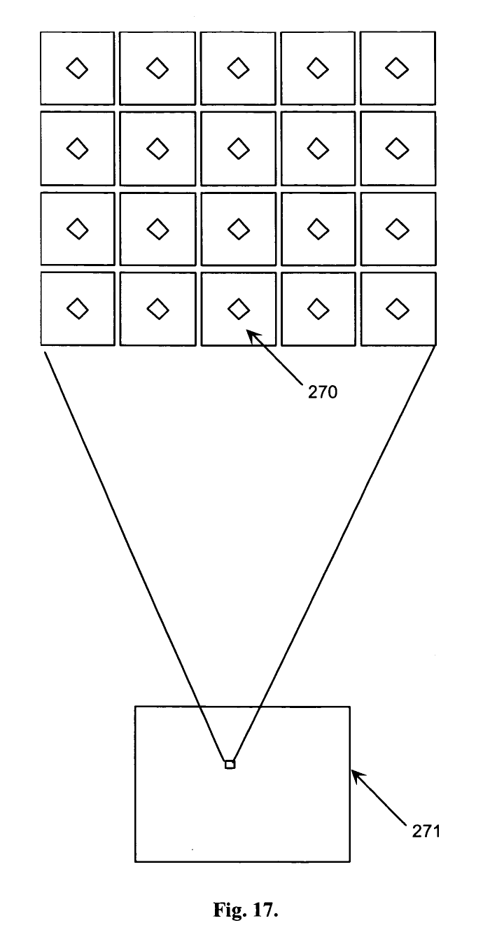

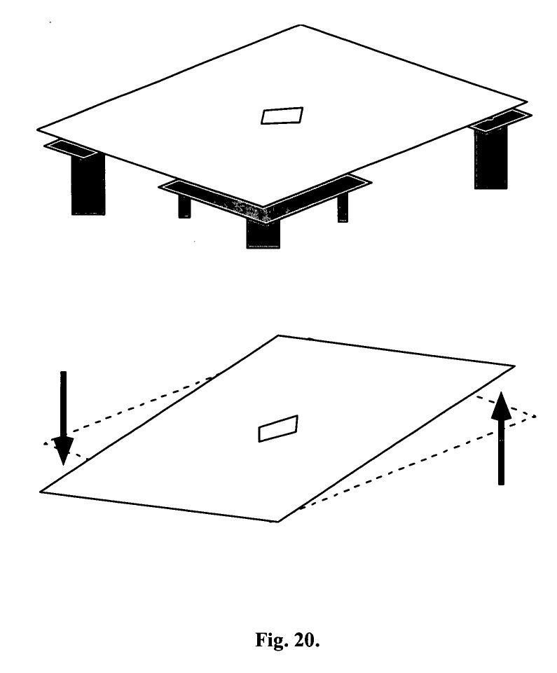

A problem with the LCD is that it can not be made completely transparent. Furthermore, it is difficult to control exactly the amount of light that passes through the LCD. Recently, a DMD (digital micromirror device) becomes available for video display systems. The DMD 271 consists of several hundred thousand or million small mirrors 270 that can be turned on and off several thousand times per second (FIG. 17). In other words, each micromirror is mounted on a tiny hinge that enables it to tilt either toward or away from the incoming light source, thus working as a light switch (FIG. 20). Therefore, with the DMD, it is possible to create a light or dark pixel on image sensing means. Thus, with the DMD which can switch several thousand times per second, it is possible to control exactly the amount of light that reaches the image-sensing means. For a bright area, the corresponding mirrors of the DMD are turned on only for a short period of time, thus limiting the amount of light that reaches the sensing means. For a dark area, the corresponding mirrors of the DMD remain turned on, thus allowing all the available light to reach the sensing means.

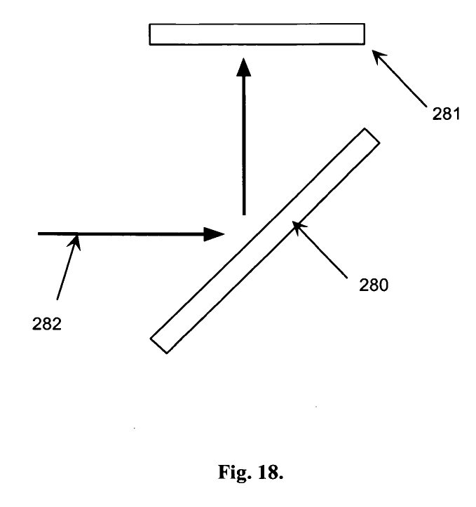

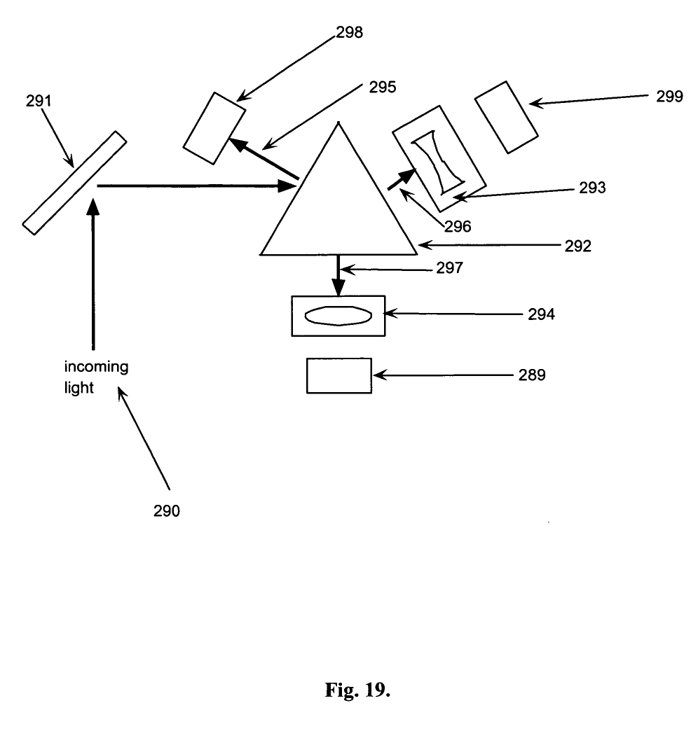

FIG. 18 illustrates how the DMD works as exposure control means. The incoming light 282 is reflected by a DMD 280 onto the image sensing means 281. By controlling each micromirror of the DMD, one can locally control the amount of light that reaches each pixel of the image sensing means 281. FIG. 19 illustrates a camera that has both focus-adjusting means and pixel-wise exposure control means. The incoming light 290 is reflected by a DMD 291 toward a prism 292. The incoming light 290, which is coming through the main lens barrel, is focused on an object in the middle. The camera has two focus-adjusting means. The long-distance focus adjusting means 293 corrects blurred images of the objects that are out of focus due to long distance. The short-distance focus adjusting means 294 corrects blurred images of the objects that are out of focus due to short distance. In other words, the first split light 295 is sensed by the first sensor 298. The second split light 296 goes through the long-distance focus adjusting means 293 and is sensed by a second sensor 299. Finally, the third split light 297 goes through the short-distance focus adjusting means 294 and is sensed by a third sensor 289. Finally, the three sensors convert the light into electrical signals and these three signals are combined to produce a sharper image or video with optimal exposure levels for all objects. The DMD 291, which is used as exposure control means, controls the amount of light that reaches each pixel of the three image sensors.

It is noted that this embodiment can be also applied to still cameras that take still pictures. It is also noted that the pixel-wise exposure control means can be used to obtain special effects. For instance, the bright area can be made brighter and the dark area can be made darker. Also, the background can be made darker.

It is further noted that this embodiment with pixel-wise exposure control means is very useful when flash or light is used, which usually produces a scene with a high level of contrast.

### Embodiment 8

In general, the computing power of the processor of a camera is limited compared with a desktop or general computer. Consequently, the operation that can be done internally is rather limited. Therefore, it will be helpful for future processing if all the images taken with different exposure and focus levels are recorded. Thus, the present invention also provides a camera that can take several images of a scene with different exposure and focus levels and save all the images for future processing. In addition, the present invention also provides a video camera that can record several videos of a scene simultaneously with different exposure and focus levels and save all the videos for future processing. Furthermore, when videos are recorded with different exposure and focus levels, such videos provide helpful information on image segmentation, which is required in certain video coding algorithms.

### Embodiment 9

Taking multiple shots with different exposure or focus levels can be made optional. In other words, the user can choose to use these features when taking pictures. Moreover, when objects are widely scattered along the z-axis, the camera produces a user alarm so that the user may activate the multiple shot option with different focus levels. Similarly, for a high-contrast scene, the camera produces a user alarm so that the user may activate the multiple shot option with different exposure levels. Alternatively, the user can activate the pixel-wise exposure control means.

### Embodiment 10

Since the human face is an object of primary interest in most applications, the focus and exposure levels can be optimized for human faces. In other words, when taking pictures or videos, the multiple shots are taken with optimal focus and exposure levels for human faces. In particular, the camera first extracts the area of the human face by applying a human-face extraction algorithm and then takes shots with optimal focus and exposure levels for the human face.

### Embodiment 11

The idea and teaching of the present invention can be also applied to infrared cameras both for still images and videos. In particular, the cameras with pixel-wise exposure control means will be very useful to increase the dynamic range of infrared cameras. For instance, a DMD can exactly control the amount of light that reaches each pixel of infrared sensors. Depending on applications, special coating on the micromirrors of the DMD can enhance the performance.

What is claimed is:

1. A camera, which has a number of image sensing means that are able to operator at different focus levels, comprising:
a plurality of image sensing means which are able to operator at different focus levels;
image storing means that comprises a nonvolatile memory;
distance sensing means that senses distances of various objects from the camera;
shot control means that takes a plurality of shots simultaneously using said plurality of image sensing means with different focus levels which are optimized for said various objects; and
combining means that combines said plurality of shots to produce a new image where said various objects are in focus and records said new image in said image storing means.

2. The camera in accordance with claim 1, wherein said plurality of image sensing means comprise CCDs.

3. A camera, which has a number of image sensing means which are able to operator at different exposure levels, comprising:
a plurality of image sensing means which are able to operator at different exposure levels;
image storing means that comprises a nonvolatile memory;
brightness sensing means that senses brightness of various objects;
shot control means that takes a plurality of shots simultaneously using said plurality of image sensing means with different exposure levels which are optimized for said various objects; and
combining means that combines said plurality of shots to produce a new image where exposure levels of said various objects are optimized and records said new image in said image storing means.

4. The camera in accordance with claim 3, wherein said plurality of image sensing means comprise CCDs.
